(19) United States
(12) Patent Application Publication
(10) Pub. No.: US 2026/0287256 A1
(43) Pub. Date: Sep. 24, 2026

(54) HEARTH MIXTURE FOR DISPOSING ON THE HEARTH BOTTOM OF AN ELECTRIC ARC FURNACE, USE OF A HEARTH MIXTURE FOR DISPOSING ON THE HEARTH BOTTOM OF AN ELECTRIC ARC FURNACE, ELECTRIC ARC FURNACE, METHOD FOR DISPOSING A HEARTH MIXTURE ON THE HEARTH BOTTOM OF AN ELECTRIC ARC FURNACE AND USE OF MAGNESIA SPINEL USED IN A LINING OF A CEMENT ROTARY KILN

(71) Applicant: REFRACTORY INTELLECTUAL PROPERTY GMBH & CO. KG, Wien (AT)

(72) Inventors: Ronald LANZENBERGER, Trofaiach (AT); David WAPPEL, Leoben (AT); Laura RECHBERGER, Kapfenberg (AT); Karl Michael ZETTL, Wien (AT); Marcos Tómas CASADO, Weiz (AT); Johannes WUCHER, Wien (AT)

(21) Appl. No.: 19/480,220

(22) PCT Filed: Apr. 30, 2024
(86) PCT No.: PCT/EP2024/061954

§ 371 Date: Oct. 30, 2025

(30) Foreign Application Priority Data
May 5, 2023 (EP) 23171834.7

(51) Int. Cl. F27B 3/14; C04B 35/04; F27B 3/08; F27D 1/00; F27D 1/16

(52) U.S. Cl. CPC F27B 3/14; C04B 35/04; F27B 3/085; F27D 1/0006; F27D 1/0043; F27D 1/16; C04B 2235/3201; C04B 2235/3206; C04B 2235/3208; C04B 2235/3217; C04B 2235/3232; C04B 2235/3262; C04B 2235/3272; C04B 2235/3418; C04B 2235/763; C04B 2235/78

(57) ABSTRACT

The invention refers to a hearth mixture for disposing on the hearth bottom of an electric arc furnace, a use of a hearth mixture for disposing on the hearth bottom of an electric arc furnace, an electric arc furnace, a method for disposing a hearth mixture on the hearth bottom of an electric arc furnace and a use of magnesia spinel used in a lining of a cement rotary kiln.

The invention refers to a hearth mixture for disposing on the hearth bottom of an electric arc furnace, a use of a hearth mixture for disposing on the hearth bottom of an electric arc furnace, an electric arc furnace, a method for disposing a hearth mixture on the hearth bottom of an electric arc furnace and a use of magnesia spinel used in a lining of a cement rotary kiln.

An electric arc furnace (EAF) is a well-known industrial furnace in which an electric arc is generated, the heat radiation of which melts solid metal present in the furnace, thereby producing molten metal in the furnace and making it available in the furnace. Electric arc furnaces are nowadays used in particular for melting down metals, including in particular the melting down and recycling of ferrous scrap. Electric arc furnaces regularly comprise a metal shell, the side walls of which at least partially can further be lined with refractory bricks. Nowadays, the bottom of modern electric arc furnaces, which is regularly called the “hearth bottom” or the “hearth” of an electric arc furnace, is regularly lined with unshaped refractory materials, i.e., so-called “hearth mixtures”, “hearth masses” or “hearth mixes”. In particular, the hearth bottom of electric arc furnaces is nowadays lined with hearth mixtures in the form of refractory masses. The hearth mixture, disposed on the hearth bottom, is heated on the hearth bottom so that the hearth mixture sinters and builds up the refractory lining of the hearth bottom. As well-known from the prior art, the hearth mixture is sintered by the heating up of the electric arc furnace and the molten metal that forms thereby.

Such hearth mixtures can be used as a hearth ramming mixture or in the form of a hearth repair mixture. As well known in the art, a hearth ramming mixture is used for the lining of the hearth bottom by disposing the hearth mixture on the hearth bottom and densification of the disposed mixture by ramming. Further, a hearth repair mixture, also known as a so-called “fettling mix”, is disposed on the lined hearth bottom in order to repair the lining of the hearth bottom in operation.

The durability of hearth mixtures disposed on the hearth bottom depends in particular on the quality of the hearth mixtures. It is particularly desirable that the hearth mixtures have special sintering properties. In particular, the hearth mixtures should have such sintering properties that the sintered hearth mixtures have a good strength, in particular, a good cold crushing strength (CCS). Further, it may be particularly desired that the hearth mixture, disposed on the hearth bottom, sinters tightly to prevent the molten metal from passing through the refractory lining. This is important, because components of the molten metal passing through the refractory lining could damage parts of the electric arc furnace located under the refractory lining, such as a permanent lining or the metal shell of the electric arc furnace. Insofar, the hearth mixtures should sinter tightly and, hence, have a small porosity. A further crucial parameter of hearth mixtures is its property to retain its original size when heated up to the relevant use temperature in order to avoid shrinkage and, hence, to avoid the build-up of gaps through which molten metal could pass.

The invention is based on the task of providing a hearth mixture for disposal on the hearth bottom of an electric arc furnace which has good sintering properties for such an application. Preferably, the hearth mixture should have such sintering properties that the sintered hearth mixture has a high strength, in particular a high cold crushing strength (CCS). A further task is to ensure that the hearth mixture sinters in such a way that, in addition to a high strength, it has as a low porosity. A further task is to ensure that the hearth mixture, while having a high strength and a low porosity, simultaneously exhibits a high dimensional stability during temperature changes.

The invention is further based on the task of providing the use of such a hearth mixture, providing an electric arc furnace with such a hearth mixture, providing a method for disposing such a hearth mixture on the hearth bottom of an electric arc furnace, and providing a use of magnesia spinel.

In order to solve the above tasks, according to the invention, there is first provided a hearth mixture for disposing on the hearth bottom of an electric arc furnace, the hearth mixture comprising the following features:
the hearth mixture comprises at least two refractory components, namely,
a first component in the form of magnesia; and
a second component in the form of recycled magnesia spinel used in a lining of a cement rotary kiln;
wherein the hearth mixture has a chemical composition comprising the following oxides in the following proportions:
Al₂O₃: 0.2 to 13% by mass;
CaO: 6 to 58% by mass;
MgO: 29 to 93.8% by mass.

The invention is based, inter alia, on the surprising finding that a hearth mixture which can solve the above tasks can be provided, insofar as this hearth mixture comprises the above features. In particular, a surprising finding of the invention is that such a hearth mixture can be provided if the mixture comprises, in addition to a first component in the form of magnesia, a second component in the form of recycled magnesia spinel, and the entire hearth mixture further has a chemical composition as indicated above. In this respect, hearth mixtures comprising magnesia are indeed known and are regularly used for lining the hearth bottom of electric arc furnaces. However, it is surprising that such hearth mixtures can be imparted particularly advantageous sintering properties, on account of which they are very advantageously suitable for lining the hearth bottom in a special way, if these hearth mixtures additionally comprise a further component in the form of recycled magnesia spinel in addition to a usual component in the form of magnesia and furthermore have the chemical composition according to the invention. In particular, it was surprisingly found in this respect according to the invention that such a hearth mixture according to the invention has such sintering properties that the sintered hearth mixture can be imparted a high strength, a low porosity and a high dimensional stability during temperature changes.

What the circumstance of these advantageous sintering properties of the hearth mixture according to the invention is based on could not be conclusively clarified by the inventors. The inventors assume that this could be based, among other things, on the fact that recycled magnesia spinel has formed a special microstructure or a special mineralogical composition during its earlier use, due to which the recycled magnesia spinel forms the advantageous sintering properties in combination with magnesia and in the presence of the chemical composition according to the invention. Surprisingly, it was found in particular according to the invention that the hearth mixture according to the invention exhibits particularly advantageous sintering properties insofar as recycled magnesia spinel is used as the second component, which has previously been used in a cement rotary kiln.

The hearth mixture according to the invention can be any of a hearth ramming mixture or a hearth repair mixture. As previously explained and well known, a hearth ramming mixture serves to be disposed on the hearth bottom of an electric arc furnace and then compacted by ramming. Further, as previously set forth and well known, a hearth repair mixture serves to repair a lining of a hearth mixture already disposed on a hearth bottom. For this purpose, the hearth repair mixture is applied to the hearth mixture already disposed to the hearth bottom, for example by spraying or simply pouring it onto the areas of the hearth mixture to be repaired.

A “recycled” magnesia spinel in the sense of the invention is a magnesia spinel as a secondary raw material, i.e., a magnesia spinel that has already been used for its original purpose and is now reused for another purpose, namely for providing a component of the hearth mixture according to the invention. In this respect, the hearth mixture according to the invention is a recyclate. The provision of the hearth mixture according to the invention, the method for disposing the hearth mixture and its use according to the invention is therefore recycling. This applies in particular because the recycled, i.e., used magnesia spinel provided for the hearth mixture according to the invention—without their use in the context of the invention—represents waste material and is now used for a new purpose in the context of the recycling according to the invention.

The original application of the recycled magnesia spinel has been its use in a cement rotary kiln. In particular, the recycled magnesia spinel, before being used as a component in the hearth mixture of the present invention, may have been used in a lining of a cement rotary kiln.

It is particularly preferred that the recycled magnesia spinel is obtained from recycled magnesia spinel bricks, i.e., magnesia spinel bricks that have already been used as set forth above.

According to a particularly preferred embodiment, the hearth mixture is free of water.

In this respect, the hearth mixture according to the invention is preferably dry and has no addition of water.

According to the invention, it was found that the sintering properties of the hearth mixture according to the invention or its properties of being advantageously usable as a hearth mixture for disposing on a hearth bottom of an electric arc furnace can be deteriorated insofar as the hearth mixture comprises proportions of water.

In particular, however, insofar as the hearth mixture is used as a hearth repair mixture, the hearth mixture may comprise proportions of oil, preferably in proportions up to at most 3% by mass, particularly preferably in proportions in the range from 1 to 3% by mass, based on the mass of the hearth mixture according to the invention without the oil.

Used magnesia spinel is a refractory material based on the mineral phases periclase (MgO) and spinel (MgO·Al₂O₃; MgAl₂O₄). Due to its previous use in an industrial high-temperature aggregate, in particular in a lining of a cement rotary kiln, the recycled magnesia spinel comprises other components besides the mineral phases MgO and MgO. Al₂O₃ or the oxides MgO and Al₂O₃, respectively. In particular, the used magnesia spinel, in addition to the oxides MgO and Al₂O₃, preferably comprises proportions of the oxide CaO. According to a preferred embodiment, the second component has a chemical composition comprising the following oxides in the following proportions:
Al₂O₃: 4 to 15% by mass, particularly preferable 6 to 12% by mass;
CaO: 0.4 to 2.5% by mass, particularly preferable 0.6 to 2.0% by mass;
MgO: remainder to 100% by mass.

The above data on the chemical composition of the second component are in each case based on the total mass of the second component.

Insofar as information is given herein on the chemical composition, this is determined in each case by means of X-ray fluorescence analysis (XRF) on the fired substance (at 1025° C.) in accordance with ISO 12677:2011-10.

As set for the above, the recycled magnesia spinel magnesia spinel is preferably obtained from recycled magnesia spinel bricks, i.e., recycled bricks based on the mineral phases periclase and spinel.

According to the invention, it was found that the sintering properties of the hearth mixture according to the invention are particularly advantageous insofar as the recycled magnesia spinel in the hearth mixture according to the invention has the above oxidic composition.

According to the invention, it was found that the sintering properties of the hearth mixture according to the invention can be further improved if the recycled magnesia spinel has a chemical composition according to which, in addition to the aforementioned proportions of Al₂O₃, CaO and MgO, the following proportions of oxides are present, in each case based on the total mass of the second component:

According to a preferred embodiment, the second component has a chemical composition comprising the oxide MgO in a proportion in the range from 82.5 to 95.6% by mass, more preferably in the range from 86 to 93.4% by mass.

According to a preferred embodiment, the second component has a chemical composition comprising the oxide Fe₂O₃ in a proportion in the range from 0.1 to 8.0% by mass, more preferable in a proportion in the range from 0.1 to 4.0% by mass and even more preferable in a proportion in the range from 0.1 to 2.0% by mass.

According to a preferred embodiment, the second component has a chemical composition comprising the oxide SiO₂ in a proportion in the range from 0.4 to 1.3% by mass.

According to a preferred embodiment, the second component has a chemical composition comprising the oxide Na₂O in a proportion in the range from 0.1 to 1.0% by mass.

According to a preferred embodiment, the second component has a chemical composition comprising the oxide K₂O in a proportion in the range from 0.1 to 5.0% by mass.

According to a preferred embodiment, the second component has a chemical composition comprising the oxide SO₃ in a proportion in the range from 0.1 to 4.0% by mass.

In particular, to the extent that the recycled magnesia spinel is in the form of a used brick lining from a cement rotary kiln, the second component may further comprise the aforementioned oxides in the form of Na₂O, K₂O and SO₃.

In accordance with the invention, it was found that the hearth mixture according to the invention has particularly advantageous sintering properties if it comprises the second component in the form of recycled magnesia spinel in a certain proportion. Thus, only minor positive effects on the sintering properties of the hearth mixture could be determined insofar as the second component was present in the hearth mixture in a proportion below 1% by mass. Furthermore, it was found that the strength, in particular the cold crushing strength, of the sintered hearth mass could be deteriorated insofar as the second component was present in proportions above 70% by mass.

According to a preferred embodiment it is therefore provided that the hearth mixture comprises a proportion of the second component in the range from 1 to 70% by mass.

According to the invention, it was found that the hearth mixture according to the invention exhibited the most advantageous sintering properties insofar as it comprised the second component in a proportion in the range from 2 to 30% by mass. According to a particularly preferred embodiment, it is therefore provided that the hearth mixture according to the invention comprises the second component in a proportion in the range from 2 to 30% by mass.

The previously given data on the proportion of the second component in the hearth mixture are in each case based on the total mass of the hearth mixture.

The hearth mixture according to the invention has a chemical composition comprising the following oxides in the following mass proportions, in each case based on the total mass of the hearth mixture according to the invention:
Al₂O₃: 0.2 to 13% by mass;
CaO: 6 to 58% by mass;
MgO: 29 to 93.8% by mass.

According to the invention, it was found that the sintering properties of the hearth mixture according to the invention are particularly advantageous if the aforementioned oxides, within the aforementioned ranges, are as close as possible to certain proportions of these oxides.

In this respect, according to a preferred embodiment, it is provided that the proportion of Al₂O₃ is as close as possible to a value of 2.0% by mass. According to a preferred embodiment, it may therefore be provided that the hearth mixture has a chemical composition comprising a proportion of Al₂O₃ of at least 0.5% by mass, more preferably of at least 1.0% by mass and even more preferably of at least 1.5% by mass. It may be provided that the hearth mixture according to the invention has a chemical composition comprising a proportion of Al₂O₃ of at most 10% by mass, more preferably of at most 8% by mass and even more preferably of at most 5% by mass. According to a preferred embodiment, it may be provided that the hearth mixture has a chemical composition comprising proportions of the oxide Al₂O₃ in the range from 0.5 to 10% by mass, more preferably in the range from 1.0 to 8% by mass, and even more preferably in the range from 1.5 to 5% by mass.

According to a preferred embodiment, it is provided that the proportion of CaO is as close as possible to a value of 20% by mass. According to a preferred embodiment, it may therefore be provided that the hearth mixture has a chemical composition comprising a proportion of CaO of at least 7% by mass, more preferably of at least 10% by mass and even more preferably of at least 15% by mass. It may be provided that the hearth mixture according to the invention has a chemical composition comprising a proportion of CaO of at most 50% by mass, more preferably of at most 40% by mass and even more preferably of at most 30% by mass. According to a preferred embodiment, it may be provided that the hearth mixture has a chemical composition comprising proportions of the oxide CaO in the range from 7 to 50% by mass, more preferably in the range from 10 to 40% by mass, and even more preferably in the range from 15 to 30% by mass.

According to a preferred embodiment, it is provided that the content of MgO is as close as possible to a value of 74% by mass. According to a preferred embodiment, it may therefore be provided that the hearth mixture has a chemical composition comprising a proportion of MgO of at least 29% by mass, more preferably of at least 50% by mass and even more preferably of at least 65% by mass. It may be provided that the hearth mixture according to the invention has a chemical composition comprising a proportion of MgO of at most 93.8% by mass, more preferably of at most 89.5% by mass and even more preferably of at most 83.5% by mass. According to a preferred embodiment, it may be provided that the hearth composition has a chemical composition comprising proportions of the oxide MgO in the range of from 29 to 93.8% by mass, more preferably in the range of from 50 to 89.5% by mass, and even more preferably in the range of from 65 to 83.5% by mass.

According to the invention, it was found that the sintering properties of the hearth mixture according to the invention can be further improved if, in addition, the following oxides are present in the following proportions:

According to a preferred embodiment, it is provided that the hearth mixture has a chemical composition which comprises Fe₂O₃ in a proportion in the range from 0.7 to 8.3% by mass.

According to a preferred embodiment, it is provided that the hearth mixture has a chemical composition which comprises SiO₂ in a proportion in the range from 0.1 to 3.5% by mass.

According to the invention, it was found that the sintering properties of the hearth mixture according to the invention are particularly advantageous if the oxides mentioned above, within the ranges mentioned above, are as close as possible to certain proportions of these oxides.

According to a preferred embodiment, it is provided that the proportion of Fe₂O₃ is as close as possible to a value of 3% by mass. According to a preferred embodiment, it may therefore be provided that the hearth mixture has a chemical composition comprising a proportion of Fe₂O₃ at least 0.7% by mass, more preferably of at least 1.5% by mass and even more preferably of at least 2% by mass. It may be provided that the hearth mixture according to the invention has a chemical composition comprising a proportion of Fe₂O₃ of at most 8.3% by mass, more preferably of at most 6% by mass and even more preferably of at most 5% by mass. According to a preferred embodiment, it may be provided that the hearth mass has a chemical composition comprising proportions of the oxide Fe₂O₃ in the range from 0.7 to 8.3% by mass, more preferably in the range from 1.5 to 6% by mass, and even more preferably in the range from 2 to 5% by mass.

According to a preferred embodiment, it is provided that the SiO₂ content is as close as possible to a value of 0.7% by mass. According to a preferred embodiment, it may therefore be provided that the hearth mixture has a chemical composition comprising a proportion of SiO₂ of at least 0.1% by mass, more preferably of at least 0.3% by mass and even more preferably of at least 0.5% by mass. It may be provided that the hearth mixture according to the invention has a chemical composition comprising a proportion of SiO₂ of at most 3.5% by mass, more preferably of at most 2.5% by mass and even more preferably of at most 1.5% by mass. According to a preferred embodiment, it may be provided that the hearth composition has a chemical composition comprising proportions of the oxide SiO₂ in the range from 0.1 to 3.5% by mass, more preferably in the range from 0.3 to 2.5% by mass, and even more preferably in the range from 0.5 to 1.5% by mass.

According to the invention, it was found that the sintering properties of the hearth mixture according to the invention can be further improved if, in addition, the following oxides are present in the following proportions, wherein these oxides can be advantageously introduced into the hearth mixture, in particular, to the extent that the recycled magnesia spinel is present in the form of a used magnesia spinel from a cement rotary kiln.

According to one embodiment, it may be provided that the hearth mixture has a chemical composition comprising the oxide Na₂O in a proportion in the range from 0.02 to 0.2% by mass.

According to one embodiment, it may be provided that the hearth mixture has a chemical composition comprising the oxide K₂O in a proportion in the range from 0.02 to 1.0% by mass.

According to one embodiment, it may be provided that the hearth mixture has a chemical composition comprising the oxide SO₃ in a proportion in the range from 0.1 to 4% by mass.

According to one embodiment, it may be provided that the hearth mixture has a chemical composition comprising the oxide MnO in a proportion in the range from 0.1 to 1.0% by mass.

According to a particularly preferred embodiment, the second component is magnesia spinel used in a lining of a cement rotary kiln.

Surprisingly, it was found in accordance with the invention that the hearth mixture according to the invention exhibits particularly advantageous sintering properties if the recycled magnesia spinel of the second component is present in the form of such a used lining of a cement rotary kiln. The inventors have not yet been able to conclusively clarify what this circumstance is based on. The inventors suspect that this may be due to a certain microstructure or mineralogical composition formed by the magnesia spinel during its use in the cement rotary kiln. In this respect, magnesia spinel bricks that have been used as lining in a cement rotary kiln exhibit typical impurities, for example in the form of alkalis (K₂O, Na₂O) or sulfites (SO₃). The inventors assume that these oxides in particular also have a positive influence on the sintering behavior of the hearth mixture according to the invention.

The first component in the form of magnesia and the second component in the form of the recycled magnesia spinel are preferably present as bulk material, i.e., in the form of grains or granular particles. In order to make recycled magnesia spinel, which was used in its original application in the form of a magnesia spinel brick, available as such a bulk material for the hearth mixture according to the invention, this used magnesia spinel can be comminuted, in particular crushed, beforehand.

According to a particularly preferred embodiment it may be provided that at least 45% by mass of the hearth mixture is present in a grain size below 3.15 mm.

Further, it can be provided that at least 95% by mass of the hearth mixture are present in a grains size below 8 mm.

According to a particularly preferred embodiment it may be provided that at least 45% by mass of the second component is present in a grain size below 3.15 mm.

Further, it can be provided that at least 90% by mass of the second component is present in a grains size below 8 mm.

According to a preferred embodiment, it can be provided that the particle size or particle size distribution of the second component essentially corresponds to the particle size distribution of the hearth mixture.

The grain size or grain size distribution specified herein is determined according to DIN ISO 1927-3.

The first component in the form of magnesia may comprise one or more magnesia-based raw materials. For example, the first component comprises at least one of the following raw materials based on magnesia: sintered magnesia or fused magnesia. These sintered magnesia or fused magnesia raw materials may be in the form of magnesia raw materials commonly used as raw material for refractory applications.

According to one embodiment, it may be provided that the hearth mixture comprises a third component in the form of a component comprising CaO.

Such a third component may be provided, in particular, when the first component and second component are not sufficient to add to the hearth mixture according to the invention the proportions of CaO according to the invention. Such a third component may, for example, be in the form of at least one of the following raw materials: limestone (i.e., a raw material based on CaCO₃), calcined limestone (i.e., a raw material based on CaO) or doloma (i.e., a raw material based on the oxides MgO and CaO).

The hearth mixture according to the invention is characterized by excellent sintering properties, which are shown in particular by a high cold crushing strength, a low porosity and a high dimensional stability of the sintered hearth mixture.

In this respect, the sintered hearth mixture according to the invention can exhibit a cold crushing strength at 1,400° C. in the range from 20 to 65 N/mm² and at 1,600° C. in the range from 35 to 75 N/mm², in each case determined according to DIN EN 933-5.

The sintered hearth mixture according to the invention can have a porosity at 1,400° C. in the range of 22 to 26 vol. % and at 1,600° C. in the range of 20 to 23 vol. %, in each case determined according to DIN EN 933-1.

The high dimensional stability with temperature change of the hearth mixture according to the invention is shown by only a slight permanent linear change in length according to DIN EN 1094-6. According to this, the hearth mixture according to the invention exhibits only a permanent change in length in the range of −1.4 to −3.9% at 1,400° C. and in the range of −3.0 to −5.0% at 1,600° C.

A further subject of the invention is the use of a hearth mixture for disposing on the hearth bottom of an electric arc furnace, the hearth mixture comprising the following features:
the hearth mixture comprises at least two refractory components, namely,
a first component in the form of magnesia; and
a second component in the form of recycled magnesia spinel used in a lining of a cement rotary kiln;
wherein the hearth mixture has a chemical composition comprising the following oxides in the following proportions:
Al₂O₃: 0.2 to 13% by mass;
CaO: 6 to 58% by mass;
MgO: 29 to 93.8% by mass.

Preferably, the hearth mixture of the use according to the invention is the hearth mixture disclosed herein according to the invention.

Preferably, the use according to the invention is carried out with the proviso that the hearth mixture in the form of a hearth ramming mixture or a hearth repair mixture is disposed on the hearth bottom of an electric arc furnace. The disposal in the form of a hearth ramming mixture or a hearth repair mixture can be carried out according to technologies known in the prior art. As is known, a hearth ramming mixture is disposed on the hearth bottom of an electric arc furnace and then compacted by ramming or vibration. A hearth repair mixture is known to be arranged on a hearth mixture disposed on the hearth bottom of an electric arc furnace to repair it. This disposal can be carried out, for example, by support of centrifugal power or simply by pouring.

A further subject of the invention is an electric arc furnace comprising:
a hearth bottom; and
a hearth mixture disposed on the hearth bottom, the hearth mixture comprising the following features:
the hearth mixture comprises at least two refractory components, namely,
a first component in the form of magnesia; and
a second component in the form of recycled magnesia spinel used in a lining of a cement rotary kiln;
wherein the hearth mixture has a chemical composition comprising the following oxides in the following proportions:
Al₂O₃: 0.2 to 13% by mass;
CaO: 6 to 58% by mass;
MgO: 29 to 93.8% by mass.

The electric arc furnace as well as the hearth bottom of the electric arc furnace may be designed according to the prior art.

Preferably, the hearth mixture disposed on the hearth bottom may be a hearth mixture according to the invention as disclosed herein.

A further subject of the invention is a method for disposing a hearth mixture on the hearth bottom of an electric arc furnace, the method comprising the following steps:
providing a hearth mixture comprising the following features:
the hearth mixture comprises at least two refractory components, namely,
a first component in the form of magnesia; and
a second component in the form of recycled magnesia spinel used in a lining of a cement rotary kiln;
wherein the hearth mixture has a chemical composition comprising the following oxides in the following proportions:
Al₂O₃: 0.2 to 13% by mass;
CaO: 6 to 58% by mass;
MgO: 29 to 93.8% by mass;
providing an electric arc furnace, comprising:
a hearth bottom;
disposing the hearth mixture on the hearth bottom.

The hearth mixture can be disposed on the hearth bottom according to technologies known from the prior art. In this regard, as previously set forth, the hearth mixture may be arranged on the hearth bottom, for example, in the form of a hearth ramming mixture or a hearth repair mixture.

Preferably, the hearth mixture provided for the method according to the invention may be in accordance with the hearth mixture disclosed herein according to the invention.

As disclosed herein, the recycled magnesia spinel of the second component may preferably be in the form of a used brick lining of a rotary cement kiln.

In this respect, the method according to the invention may preferably be preceded by the following process steps:
breaking out magnesia spinel used in a lining of a cement rotary kiln from said lining;
providing the broken-out magnesia spinel as the second component for the hearth mixture.

The broken-out magnesia spinel can, as explained above, preferably be made available as bulk material. For this purpose, the broken-out magnesia spinel can preferably be comminuted. According to a preferred embodiment, it can therefore be provided that between the process step of breaking out the magnesia spinel from the cement rotary kiln and making it available as a second component, the broken-out magnesia spinel is comminuted, preferably comminuted into a bulk material. Particularly preferably, it can be provided that this is comminuted in such a way that it has the grain size or grain size distribution described above.

A further subject of the invention is the use of magnesia spinel used in a lining of a cement rotary kiln as a component in a hearth mixture for disposing on the hearth bottom of an electric arc furnace, the hearth mixture comprising the following features:
the hearth mixture comprises at least two refractory components, namely,
a first component in the form of magnesia; and
a second component in the form of recycled magnesia spinel used in a lining of a cement rotary kiln;
wherein the hearth mixture has a chemical composition comprising the following oxides in the following proportions:
Al₂O₃: 0.2 to 13% by mass;
CaO: 6 to 58% by mass;
MgO: 29 to 93.8% by mass.

The used magnesia spinel of the use according to the invention may preferably be in the form of the recycled magnesia spinel described herein. Further, the hearth mixture of the use according to the invention may preferably be in the form of the hearth mixture described herein according to the invention.

Further features of the invention will be apparent from the claims and the following description of embodiments of the invention.

All features of the invention may be combined, individually or in combination, in any desired manner.

Examples of embodiments of the invention are described in more detail below.

### EXEMPLARY EMBODIMENTS

### Hearth Mixture

For the provision of an exemplary embodiment of the hearth mixture according to the invention, two components were provided, namely a first component in the form of magnesia and a second component in the form of recycled magnesia spinel.

The first component in the form of magnesia was in the form of commercial sintered magnesia. This magnesia had the following chemical composition, each based on the total mass of the magnesia:
MgO: 72.7% by mass
CaO: 23.0% by mass
Fe₂O₃: 3.4% by mass
SiO₂: 0.8% by mass
Al₂O₃: 0.4% by mass.

The recycled magnesia spinel had previously been used as a component of the lining of a cement rotary kiln. In order to provide this used magnesia spinel as a second component for the embodiment of the hearth mixture, this magnesia spinel had been broken out of the cement rotary kiln, subsequently crushed and finally provided as recycled magnesia spinel for the hearth mixture. The recycled magnesia spinel had the following chemical composition, in each case based on the total mass of the recycled magnesia spinel:
MgO: 83.5% by mass,
Al₂O₃: 9.3% by mass,
CaO: 1.6% by mass,
Fe₂O₃: 0.7% by mass,
SiO₂: 0.6% by mass,
Na₂O: 0.1% by mass,
K₂O: 1.7% by mass,
SO₃: 2.5% by mass,
further oxides: 0.1% by mass.

Four embodiments of a hearth mixture according to the invention were then prepared from such first and second component. For this purpose, the first component and the second component were mixed with each other in different proportions, with the mass percentage of the second component, based on the total mass of the first and second components, being 2% by mass (Example A), 6% by mass (Example B), 10% by mass (Example C) and 20% by mass (Example D).

Two hearth mixtures E and F not according to the invention were also prepared for comparison purposes. Hearth mixture E only comprised the first component of the above embodiments of the hearth mixture according to the invention. The hearth mixture F comprised the first component of the embodiments of the hearth mixture according to the invention and, in addition, a proportion of 2% by mass of an unused, commercially available magnesia spinel in a particle size according to the second component.

The chemical composition and the particle size distribution of the four embodiments A to D of the hearth mixture according to the invention and of the hearth mixtures not according to the invention according to the comparative examples E and F are given in Table 1 below (data on oxides in each case in “% by mass” and on particle size in each case in “mm”, based in each case on the respective total mass of the hearth mixture).

TABLE 1

| | Exemplary embodiments | | | | Comparative examples | |
|---|---|---|---|---|---|---|
| | A | B | C | D | E | F |
| Oxide | | | | | | |
| MgO | 71.3 | 71.8 | 72.1 | 73.7 | 70.8 | 71.3 |
| CaO | 23.4 | 22.6 | 21.8 | 19.7 | 23.9 | 23.4 |
| Al₂O₃ | 0.4 | 0.8 | 1.2 | 2.0 | 0.3 | 0.4 |
| Fe₂O₃ | 3.7 | 3.5 | 3.4 | 3.0 | 3.8 | 3.7 |
| SiO₂ | 0.7 | 0.7 | 0.7 | 0.7 | 0.7 | 0.7 |
| Na₂O | 0.0 | 0.0 | 0.0 | 0.0 | 0.0 | 0.0 |
| K₂O | 0.0 | 0.1 | 0.2 | 0.3 | 0.0 | 0.0 |
| SO₃ | 0.0 | 0.0 | 0.1 | 0.1 | 0.0 | 0.0 |
| MnO | 0.5 | 0.5 | 0.4 | 0.4 | 0.5 | 0.5 |
| TiO₂ + P₂O₅ | 0.0 | 0.0 | 0.1 | 0.1 | 0.0 | 0.0 |
| Grain size | | | | | | |
| <0.063 | 9.0 | 10.0 | 11.0 | 9.0 | 10.0 | 11.0 |
| <1.0 | 47.0 | 45.0 | 46.0 | 47.0 | 47.0 | 49.0 |
| <3.15 | 59.0 | 58.0 | 60.0 | 61.0 | 61.0 | 60.0 |
| <8.0 | 100.0 | 100.0 | 100.0 | 100.0 | 100.0 | 100.0 |

In order to determine the sintering properties of the four exemplary embodiments A to D and of the comparative examples E and F of the hearth mixture according to Table 1, the cold crushing strength (“CCS”), porosity and permanent linear change of these six embodiments were determined according to the standards indicated above.

The results of the measurements are shown in Table 2 below.

TABLE 2

| | Exemplary embodiments | | | | Comparative examples | |
|---|---|---|---|---|---|---|
| | A | B | C | D | E | F |
| CCS | 18.4 | 19.7 | 23.5 | 26.1 | 16.50 | 16.4 |
| 1,400° C. | | | | | | |
| [N/mm²] | | | | | | |
| CCS | 34.0 | 38.2 | 45.2 | 41.7 | 32.0 | 31.8 |
| 1,600° C. | | | | | | |
| [N/mm²] | | | | | | |
| Porosity | 24.8 | 24.5 | 23.8 | 22.9 | 25.6 | 25.6 |
| 1,400° C. | | | | | | |
| [Vol.-%] | | | | | | |
| Linear | −3.804 | −3.730 | −2.805 | −1.450 | −3.855 | −3.896 |
| change | | | | | | |
| 1,400° C. | | | | | | |
| [%] | | | | | | |

As can be seen from Table 2, the four embodiments A to D of the hearth mixture according to the invention exhibit excellent sintering properties, in particular a high cold crushing strength, low porosity and low permanent linear change. This makes the embodiments of the hearth mixture according to the invention particularly suitable for use for disposal on the hearth bottom of an electric arc furnace. In particular, however, the four embodiment examples A to D also exhibit better properties than the comparative examples E and F.

### ELECTRIC ARC FURNACE

An exemplary embodiment of an electric arc furnace is shown in the accompanying FIGURE.

Thereby shows

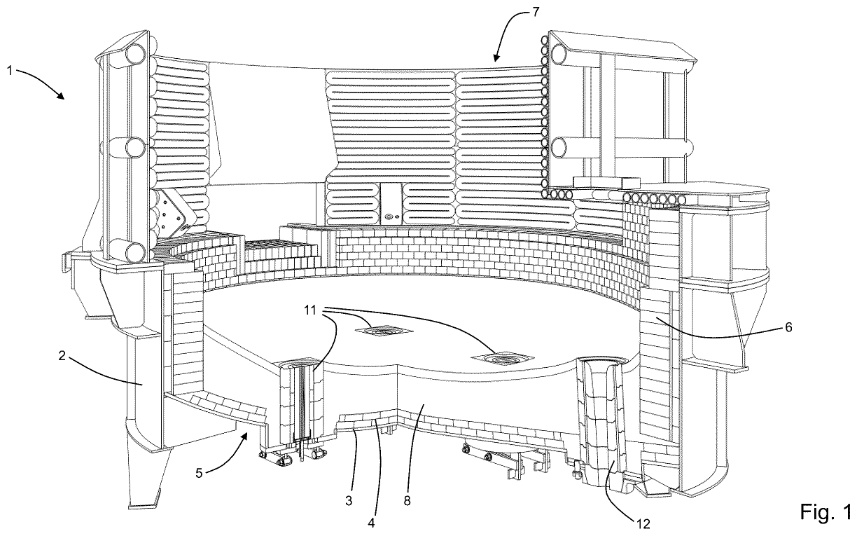

FIG. 1 a schematized exemplary embodiment of an electric arc furnace according to the invention comprising an exemplary embodiment according of a hearth mixture according to the invention.

The exemplary embodiment of an electric arc furnace (1) according to FIG. 1 is shown in a perspective, lateral sectional view.

The electric arc furnace (1) comprises, as known from the prior art, a metal shell (2) comprising a bottom-side section (3). A permanent lining (4) in the form of a lining of refractory bricks is arranged on the bottom-side section (3) of the metal shell (2). The section (3) with the permanent lining (4) arranged thereon together form the hearth bottom (5) of the electric arc furnace (1). On the side wall, the lower section of the metal shell (2) is lined with a side wall wear lining (6) in the form of a brick lining made of refractory bricks. Enclosed by the electric arc furnace (1) is a furnace chamber (7) designed to hold molten metal.

In the area of the hearth bottom (5), the electric arc furnace (1) further has the components known from the prior art, such as purging plugs (11) and a bottom tapping (12).

An embodiment of one of the exemplary embodiments A to D of the hearth mixture (8) according to the invention is disposed on the bottom (5).

The hearth mixture (8) is used as a hearth ramming mixture and disposed directly on the hearth bottom (5).

In order to provide the hearth mixture (8) on the bottom (5), the hearth mixture (8) was disposed in several layers on the hearth bottom (5) according to the prior art, each layer being compacted by ramming. In particular cases, especially if the inclination of the bank exceeds 35°, a template may be used for disposing the material. Alternatively, also special mixes including oil up to 3% may be used to allow the formation of the steep bank without the use of a template. After the ramming step, the hearth mixture (8) was present as a monolithic layer on the hearth bottom (5).

The hearth mixture (8) is disposed in a thickness of 800 mm.

When the electric arc furnace (1) started up, it was found that the hearth mixture (8) sintered tightly at an early stage due to the molten metal forming in the furnace chamber (7) and was able to prevent components of the molten metal and slag from infiltration into and passing through the refractory lining which was built up by the sintered hearth mixture (8). Furthermore, as set forth herein before, the sintered hearth mixture (8) showed an excellent cold crushing strength, a low porosity and a low linear change.

1. A hearth mixture for disposing on the hearth bottom of an electric arc furnace, the hearth mixture comprising the following features:
1.1 the hearth mixture comprises at least two refractory components, namely,
1.1.1 a first component in the form of magnesia; and
1.1.2 a second component in the form of recycled magnesia spinel used in a lining of a cement rotary kiln;
1.2 wherein the hearth mixture has a chemical composition comprising the following oxides in the following proportions:
1.2.1 Al₂O₃: 0.2 to 13% by mass;
1.2.2 CaO: 6 to 58% by mass;
1.2.3 MgO: 29 to 93.8% by mass.

2. The hearth mixture according to claim 1, wherein the hearth mixture is free of water.

3. The hearth mixture according to claim 1, wherein the hearth mixture comprises a proportion of the second component in the range from 1 to 70% by mass.

4. The hearth mixture according to claim 1, wherein the second component has a chemical composition comprising the following oxides in the following proportions:
Al₂O₃: 4 to 15% by mass;
CaO: 0.4 to 2.5% by mass;
MgO: remainder to 100% by mass.

5. The hearth mixture according to claim 1, wherein the chemical composition of the hearth mixture comprises Fe₂O₃ in a proportion in the range from 0.7 to 8.3% by mass.

6. The hearth mixture according to claim 1, wherein the chemical composition of the hearth mixture comprises SiO₂ in a proportion in the range from 0.1 to 3.5% by mass.

7. The hearth mixture according to claim 1, wherein at least 45% by mass of the hearth mixture is present in a grain size below 3.15 mm.

8. The hearth mixture according to claim 1, wherein at least 45% by mass of the second component is present in a grain size below 3.15 mm.

9. The hearth mixture according to claim 1, wherein the hearth mixture comprises a third component in the form of a component comprising CaO.

10. (canceled)

11. An electric arc furnace comprising:
11.1 a hearth bottom; and
11.2 a hearth mixture disposed on the hearth bottom, the hearth mixture comprising the following features:
11.2.1 the hearth mixture comprises at least two refractory components, namely,
11.2.1.1 a first component in the form of magnesia; and
11.2.1.2 a second component in the form of recycled magnesia spinel used in a lining of a cement rotary kiln;
11.2.2 wherein the hearth mixture has a chemical composition comprising the following oxides in the following proportions:
11.2.2.1 Al₂O₃: 0.2 to 13% by mass;
11.2.2.2 CaO: 6 to 58% by mass;
11.2.2.3 MgO: 29 to 93.8% by mass.

12. A method for disposing a hearth mixture on the hearth bottom of an electric arc furnace, the method comprising the following steps:
C. providing a hearth mixture comprising the following features:
C.1 the hearth mixture comprises at least two refractory components, namely,
C.1.1 a first component in the form of magnesia; and
C.1.2 a second component in the form of recycled magnesia spinel used in a lining of a cement rotary kiln;
C.2 wherein the hearth mixture has a chemical composition comprising the following oxides in the following proportions:
C.2.1 Al₂O₃: 0.2 to 13% by mass;
C.2.2 CaO: 6 to 58% by mass;
C.2.3 MgO: 29 to 93.8% by mass;
D. providing an electric arc furnace, comprising:
D.1 a hearth bottom;
E. disposing the hearth mixture on the hearth bottom.

13. The method according to claim 12, preceded by the following steps:
A. breaking out magnesia spinel used in a lining of a cement rotary kiln from said lining;
B. providing the broken-out magnesia spinel as the second component for the hearth mixture.

14. (canceled)
